(19) United States
(12) Patent Application Publication
(10) Pub. No.: US 2009/0172640 A1
(43) Pub. Date: Jul. 2, 2009

(54) Medical Device With Full Options and Selective Enablement/Disablement

(75) Inventors: Eric P. Geismar, Encino, CA (US); Bradley J. Enegren, Moorpark, CA (US); Paul H. Kovelman, Simi Valley, CA (US); Mike Charles Vallet Tolle, Van Nuys, CA (US); Gary L. Williams, Gardena, CA (US); Gary A. Cohen, Sherman Oaks, CA (US); Sheldon B. Moberg, Thousand Oaks, CA (US)

Correspondence Address: FOLEY & LARDNER, 555 South Flower Street, SUITE 3500, LOS ANGELES, CA, 90071-2411, US

(73) Assignee: Medtronic MiniMed, Inc.

(21) Appl. No.: 11/964,663

(22) Filed: Dec. 26, 2007

(51) Int. Cl. G06F 9/44

(52) U.S. Cl. 717/121

(57) ABSTRACT

According to one embodiment, a programmable medical device includes a storage means for storing a plurality of software modules operable to control one or more medical functions of the device. The device is configured to receive a plurality of commands. An operational state of each of the software modules is configured to be controlled according to a respective one of the commands.

### FIELD OF THE INVENTION

Embodiments of the present invention relate to a programmable medical device and a method of programming a medical device. Further embodiments relate to a programmable medical device having one or more features or functions capable of being selectively enabled and/or disabled.

### BACKGROUND

Traditionally, a programmable medical device includes a memory for storing software (or firmware) for implementing features (or functions) of the programmable medical device. After a period of time from when the device has left the manufacturer, the software stored in the device may be updated (or upgraded) at selected times or time intervals over the operational lifetime of the device. As such, the features of the device can be modified and/or improved accordingly.

A programmable pump is an example of such a programmable medical device. The pump delivers a medication or other substance to a patient-user's body, either in a continuous manner or at particular times or time intervals within an overall time period. For example, the chronic disease of diabetes is commonly treated by delivering defined amounts of insulin to the patient-user at appropriate times.

The programmable pump may be used, for example, for the treatment of diabetes. Here, the pump may be employed to deliver controlled amounts of insulin to the patient-user. In more detail, such a pump may be employed to calculate and deliver specific doses of insulin to the patient-user at any time during the day or night. Furthermore, when used in conjunction with glucose sensors or monitors, such a pump may be automatically controlled to provide appropriate doses of infusion medium at appropriate times of need, based on sensed or monitored levels of blood glucose.

A programmable medical device such as the devices described above may be used in conjunction with a communication system. The system may include a communication station having a cradle for receiving the programmable medical device, and for interfacing with a peripheral device such as a personal computer or the like. By arranging the programmable medical device in communication with the peripheral device, software and/or instructions may be transferred from the peripheral device to the programmable medical device. In addition, data may be transferred from the medical device to the peripheral device.

### BRIEF DESCRIPTION OF THE DRAWINGS

FIG. 1 is a generalized diagram of a medical system in relation to a human patient-user.

FIG. 2 is a block diagram of a medical system according to an embodiment of the invention.

FIG. 3 is a block diagram of software stored in a programmable medical device of FIG. 2, according to an embodiment of the invention.

FIG. 4 is a block diagram of a programmable medical device according to another embodiment of the present invention.

### DETAILED DESCRIPTION

The present invention relates, generally, to programmable medical devices and methods of programming a medical device. The programmable medical device includes software (or firmware) according to which it provides one or more features (or functions), for example, as part of medical treatment (or therapy) for the benefit of a patient. Embodiments of the invention may be configured, as described herein, to provide a reliable, cost-effective and easy-to-use mechanism for providing selected treatment or therapeutic services to a patient.

Embodiments of the present invention include software that implements one or more aspects of the operation of the programmable medical device. In particular embodiments, the installation of the software in the device is performed at or around the time of the device manufacture, e.g., before the device is distributed and/or sold, or before the device leaves the manufacturing facility. Here, the software may be tested at or around the time of manufacture. As such, the functionality of the software may be tested and verified in whole (or at least in part). In addition, compatibility of the software with one or more hardware elements of the device may be tested and verified in whole or (or at least in part). Similarly, compatibility of one or more modules of the software with one or more other modules of the software may be tested and verified.

In further embodiments, the device is configured to accept and install software updates after the time of manufacture. For example, the software updates may replace (e.g., “write over”) all or a portion of previously installed software. In the latter situation, procedures may be taken to ensure that the software updates are compatible with the remaining portion of the previously installed software. As another example, the software updates may supplement the previously installed software. Here, the previously installed software remains in place and, as such, remain fully (or at least partially) operational after the software updates have been installed. In addition, procedures may be taken to ensure that the software updates are compatible with the previously installed software.

In addition, in embodiments of the present invention, the device may be configured to operate in conjunction with one or more other devices, which, in turn, may be programmable or non-programmable. In other embodiments, the device may be configured to operate as an independent programmable device (e.g., a largely stand-alone device). Here, in particular embodiments, the device may include one or more switches and/or controls. Via the switches and/or controls, the device may be configured to provide certain additional features or functions (or, conversely, to refrain from providing certain features or functions). In addition, via the switches and/or controls, the device may be configured to accept software and/or firmware updates that are loaded to the device. Here, if the device is secured within the body of a patient-user, such configuration of the device may occur once the device has been extracted from the body.

In particular embodiments, where the device is secured within the body of the patient-user and the device is configured to operate in conjunction with one or more other devices, further configuration of the device may occur while the device remains secured within the body. As such, extraction of the device from the body of the patient-user is not necessary. In further embodiments, the device is enclosed, for example, within a waterproof seal or covering, such as a hermetic seal. As such, the device is designed to resist permeation by fluids and/or other substances produced within the body. Furthermore, in particular embodiments, as will be described in more detail below, the device is configured to communicate with the one or more other devices via a wireless communication link, e.g., a radio frequency (RF) communication link.

While embodiments of the present invention are described herein with reference to an insulin delivery device (e.g., a medical pump) for treating diabetes, other embodiments of the invention may be employed for delivering other infusion media to a patient-user for other purposes. For example, further embodiments of the invention may be employed for delivering other types of drugs to treat diseases or medical conditions other than diabetes, including, but not limited to drugs for treating pain or certain types of cancers, pulmonary disorders or HIV.

Further embodiments may be employed for delivering media other than drugs, including, but not limited to, nutritional media including nutritional supplements, dyes or other tracing media, saline or other hydration media, or the like. For example, further embodiments may be employed for delivering certain amounts of electrical energy to treat conditions such as a cardiac arrhythmia (e.g., a cardiac defibrillator). Also, while embodiments of the present invention are described herein for delivering or infusing an infusion medium to a patient-user, other embodiments may be configured to draw a medium from a patient-user.

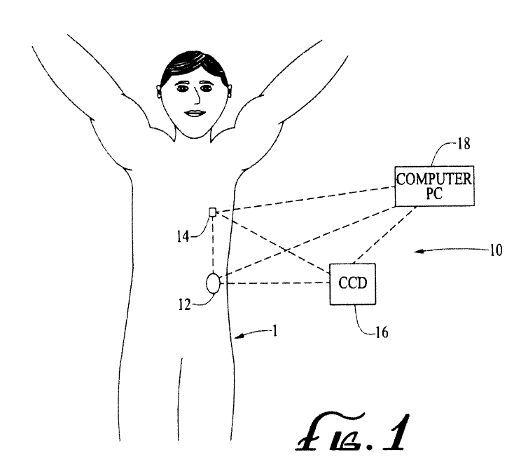

A generalized representation of a medical device system 10 is shown in FIG. 1, wherein the system includes a medical device 12 configured according to an embodiment of the invention described herein. The system 10 may also include other components coupled for communication with the medical device 12, including, but not limited to, a sensor or monitor 14, a command control device (CCD) 16 and a computer 18. Each of the CCD 16, the computer 18, the sensor or monitor 14 and the medical device 12 may include receiver or transceiver electronics that facilitate communication with other components of the system.

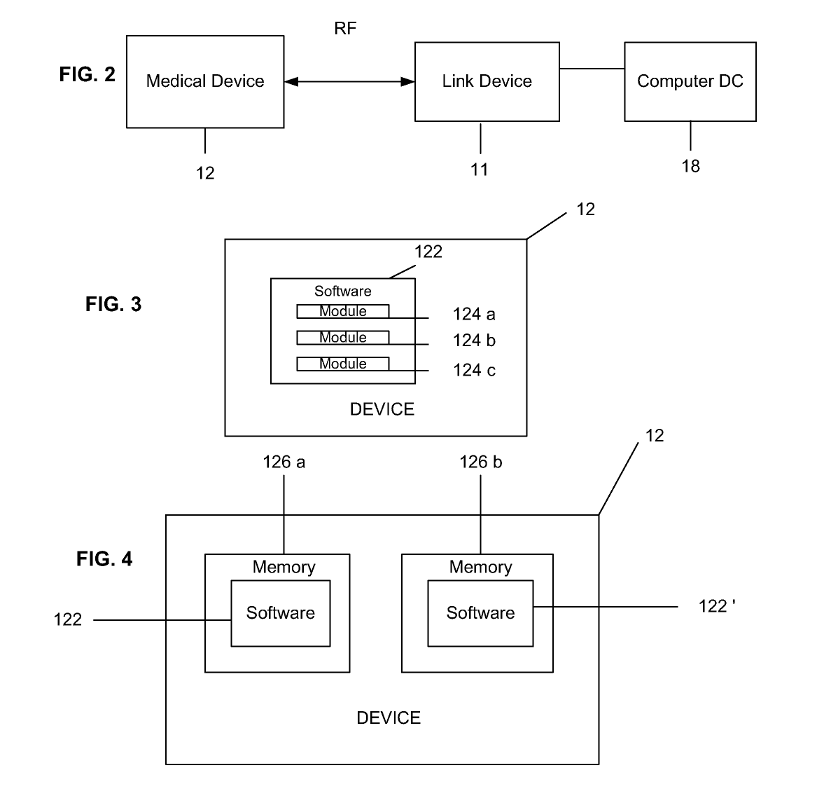

For example, as shown in FIG. 2, the medical device 12 may communicate via the computer 18 via an RF communication link and a programming link device 11. While the link device 11 is shown as a separate element relative to the computer 18, in other embodiments, the link device 11 may be incorporated within the computer 18.

With reference back to FIG. 1, while the sensor or monitor 14 in FIG. 1 is shown as a separate element relative to the medical device 12 and connected thereto through a communication link, in other embodiments, the sensor or monitor 14 may be incorporated within the medical device 12. The medical device 12 may include electronics and software for analyzing sensor data and for performing a treatment (e.g., delivering an infusion medium, delivering electrical energy, etc.) according to sensed data and/or pre-programmed treatment routines. Some of the processing, treatment routine storage and control functions may be carried out by the CCD 16 and/or the computer 18, to allow the medical device 12 to be made with more simplified electronics. However, in other embodiments, the system 10 may include medical device 12 that operates without one or more of the other components of the system 10 shown in FIG. 1. Examples of the types of communications and/or control capabilities, as well as device feature sets and/or program options may be found in U.S. patent application Ser. No. 10/445,477 filed May 27, 2003, and entitled “External Infusion Device with Remote Programming, Bolus Estimator and/or Vibration Alarm Capabilities,” U.S. patent application Ser. No. 10/429,385 filed May 5, 2003, and entitled “Handheld Personal Data Assistant (PDA) with a Medical Device and Method of Using the Same,” and U.S. patent application Ser. No. 09/813,660 filed Mar. 21, 2001, and entitled “Control Tabs For Infusion Devices And Methods Of Using The Same,” all of which are incorporated herein by reference in their entirety.

In the generalized system diagram of FIG. 1, the medical device 12 and sensor or monitor 14 are secured within the body of a patient-user 1. The locations at which those components are secured to the patient-user 1 in FIG. 1 are provided only as a representative, non-limiting example. The medical device 12 and sensor or monitor 14 may be secured at other locations on the patient-user 1 (including, but not limited to, locations on the patient-user's skin, clothing, belt, suspenders, straps, purse or other portable holder), and such locations may depend upon the type of treatment (or therapy) to be administered by the system 10.

As described in further detail below, the medical device 12 includes software (or firmware) for implementing features or processes of the device. Software code, control instructions and/or data may be communicated between the medical device 12, the sensor or monitor 14, the CCD 16 and the computer 18. The medical device 12 may be configured to be secured within the body of the patient-user or to be secured to the skin of a patient-user 1 (e.g., in the manner of a patch) at a desired location on the patient-user. In such embodiments, it is desirable that the medical device 12 have relatively small dimensions for logistical purposes, comfort and/or ability to conceal the device, for example, under a garment.

A generalized representation of operation software 122 stored in a medical device 12 configured according to an embodiment of the invention described herein is shown in FIG. 3. The software 122 includes one or more modules 124. In one embodiment, in operation, the modules may execute independent of one another. In other embodiments, some of the modules may be inter-dependent or related to each other in some manner. In one embodiment, the modules 124 are compartmentalized, i.e., each of the modules 124 corresponds to one or more features or functions provided by the medical device 12.

For example, in the context of a programmable pump: one of the modules 124 may be configured to specify the triggering of the pump mechanism (e.g., at a certain time of the day or night, upon a receipt of a signal, such as a signal indicating a certain insulin level as sent by the monitor 14); another of the modules 124 may be configured to provide device-history features (e.g., graphing of dosage levels delivered by the pump and the associated delivery times, report generation of delivered dosage levels); another one of the modules 124 may be configured to specify the dosage level(s) and corresponding delivery times of periodically delivered dosages); and another of the modules 124 may be for specifying the dosage level and delivery time of a bolus (e.g., a dosage delivered to supplement any periodically delivered dosages). The above features are presented by way of example only, and embodiments of the present invention are not limited thereto.

With continued reference to FIG. 3, each of the modules 124 can be controlled to be operational or non-operational (unlocked or locked). When a particular one of the modules 124 is controlled to be operational (e.g., unlocked), the module can be executed such that the medical device 12 can be operated to provide the features or functions. For example, when a particular one of the modules 124 is unlocked, the dosage level of a bolus may be input to the medical device 12 and stored in the module 124. In contrast, when a particular one of the modules 124 is controlled to be non-operational (e.g., locked), the module cannot be executed. As such, the medical device cannot be operated to provide the features or functions corresponding to that module. For example, when a particular one of the modules 124 is locked, the dosage level of a bolus, as stored in the module 124, may not be reset of changed.

In particular embodiments, the operational/non-operational state of a particular one of the modules 124 may be controlled (e.g., toggled) only a certain number of times. In other embodiments, the number of times that the state of the module can be controlled is not limited.

As described above, by selecting the modules 124 to be operational or non-operational, the medical device 12 is configured such that it can be operated to provide different combinations of features over the lifetime of the device 12.

As an example, in one embodiment, at or around the time of manufacture, the medical device 12 is configured to include each of modules 124a, 124b, and 124c. However, by default, only module 124a is controlled to be operational. That is, modules 124b and 124c are controlled to be non-operational. Here, it may be preferred to present a patient-user with a device that is more easy to operate, rather than a device that has a variety of features. After the device has been in use for a certain period of time, a physician (or some other medical professional) may decide that the medical device 12 should be further configured such that it can be operated to provide one or more additional features, in addition to the features corresponding to the module 124a. Here, the modules 124b and/or 124c may be also selected to be operational.

Alternatively, the doctor may decide that the medical device 12 be reconfigured such that it can be operated to provide a set of one or more features, rather than the features corresponding to the module 124a. Here, the physician may opt to select the modules 124b and/or 124c to be operational and the module 124a to be non-operational.

In one embodiment, the operational state of each of the modules 124a, 124b, 124c can be selected using a command issued via the computer 18 and the link device 11. In more detail, one command is employed to select the operational state of module 124a, another command is employed to select the operational state of module 124b, and yet another command is employed to select the operational state of module 124c. In other embodiments, one command may be employed to select the operational states of more than one module (e.g., a group of related modules). For example, one command may be employed to select the operational state of both module 124b and module 124c. That is, one command is employed to configure both module 124b and module 124c to be operational or non-operational. Here, the functions corresponding to modules 124b and 124c may be related in a manner such that it is desirable to configure the operational states thereof concurrently.

As described above, each of the modules 124a, 124b and 124c can be configured to be operational or non-operational (i.e., on or off). As such, the medical device 12 can be commanded to be effectively converted from one model to another. As such, manufacturing processes and procedures (and other associated processes and procedures, e.g., those relating to marketing and/or inventory control) may be substantially simplified and streamlined.

As an example, one manufactured device (e.g., one specific model), in which all three of the modules are installed, can effectively take the place of up to seven individual devices (e.g., seven individual models), where selective enabling/disabling, according to embodiments of the present invention, is not provided. Here, the seven individual devices include: (1) a device including module 124a only; (2) a device including module 124b only; (3) a device including module 124c only; (4) a device including modules 124a and 124b only; (5) a device including modules 124a and 124c only; (6) a device including modules 124b and 124c only; and (7) a device including modules 124a, 124b and 124c. In embodiments where the software 122 includes more than three modules, medical devices according to embodiments of the present invention can effectively take the place of a greater number of individual devices—e.g., up to 15 individual devices where all of four modules are installed in a manufactured device, and up to 31 individual devices where all of five modules are installed in a manufactured device. That is, where all of N modules are installed in a manufactured device (N being an integer greater than 1), the device can effectively take the place of (2N−1) individual devices. Here, the modules may be pre-tested before they are installed such that it can be verified that combinations of the modules will be compatible with one another.

As previously described, in embodiments of the present invention, the medical device 12 may accept additional software modules after the time of manufacture. For example, in one embodiment, the medical device 12 may be manufactured to include several empty software slots. Thus, over the lifetime of the device, an additional module may be installed at one of these empty slots. Similar to the modules 124a, 124b, 124c described previously, these additional modules may also be controlled to be operational and non-operational. Further, each of these additional modules may correspond to one or more features or functions to be provided by the medical device 12.

As previously described, validating procedures might be taken to ensure that any additional software modules are compatible with combinations of modules of the previously installed software. As a result of a successful validating procedure, a validation code may be included in an additional module (or as part of the transmission thereof). Here, in embodiments of the present invention, the medical device 12 may be configured to recognize the validation code such it can lock out (e.g., preempt the execution of) additional modules for which evidence of pre-testing is not indicated.

As described above, the medical device 12 can be updated to include new software components without requiring the transfer of a complete software package. In transferring a smaller component rather than a larger package, the probability of transmission errors (encountered during the upload or transfer of software) can be reduced. However, in embodiments of the present invention, the medical device 12 may be configured to provide additional safeguards relating to the upload of additional software modules. For example, the medical device 12 may be configured to compute and compare checksums of the additional software modules, or it may conduct a page-by-page read of the additional software modules. In another embodiment, the medical device 12 may be configured to initiate a user-interactive process by which execution of the additional software modules is monitored and validation such that it is ensured that the upload was correct.

In further embodiments, the medical device 12 may be configured to provide additional safeguards. Here, the medical device 12 may include two or more separate memory areas (or two separate memory devices such as RAMs) 126a and 126b, as shown in FIG. 4. Here, one of the memory areas is reserved for storing a first copy (e.g., a validated copy) 122 of the software of the device. The other one of the memory areas is reserved for storing a second copy 122′ of the software of the device. This second copy 122′ is provided for receiving any additional software modules such as those described above. That is, an additional software module (or modules) is (or are) installed to be part of the second copy 122′ of the software. As a safeguard, if any problems or errors are encountered in the transfer of the additional modules or if the execution of the second copy 122′ of the software results in any problems or errors, the device 12 can operate according to the first copy 122 rather than the second copy 122′.

Various aspects of the multiple embodiments described above may be employed independently or in combinations thereof. While particular embodiments of the present invention have been shown and described, it will be obvious to those skilled in the art that the invention is not limited to the particular embodiments shown and described and that changes and modifications may be made without departing from the spirit and scope of the claimed invention. For example, while embodiments are described above in the context of delivery devices for delivering an infusion medium to a patient-user, other embodiments may be operated to withdraw a fluidic medium from a patient-user (or other source).

What is claimed is:

1. A programmable medical device comprising:
a storage means for storing a plurality of software modules operable to control one or more medical functions of the device,
wherein the device is configured to receive a plurality of commands, and
wherein an operational state of each of the software modules is configured to be controlled according to a respective one of the commands.

2. The device as recited in claim 1, wherein each of the software modules is operable to control the device to execute one or more corresponding processes.

3. The device as recited in claim 1, wherein the operational states of two of more of the software modules are configured to be controlled according to a same one of the commands.

4. The device as recited in claim 1, wherein the device is configured to receive the commands via a wireless communication link.

5. The device as recited in claim 1, wherein the device is configured to receive at least one additional software module operable to control the device via the wireless link.

6. The device as recited in claim 5, wherein an operational state of the at least one additional software module is configured to be controlled according to a respective one of the commands.

7. The device as recited in claim 6,
wherein the at least one additional software module comprises a first additional module and a second additional module, and
wherein the operational states of the first additional module and the second additional module are configured to be controlled according to a same second one of the commands.

8. The device as recited in claim 5,
wherein the storage means comprises a first storage area and a second storage area,
wherein the first storage area is for storing the software modules, and
wherein the second storage area is for storing the software modules and the at least one additional software module.

9. The device of claim 8, wherein the device is configured to be controlled by either the software modules stored in the first storage area or the software modules and the at least one additional software module stored in the second storage area.

10. The device as recited in claim 1, wherein the device is a programmable pump.

11. The device as recited in claim 1, wherein the device is a defibrillator.

12. A method for operating a programmable medical device, the method comprising:
storing in the programmable medical device a plurality of software modules operable to control one or more medical functions of the device; and
sending to the device a plurality of commands,
wherein an operational state of each of the software modules is configured to be controlled according to a respective one of the commands.

13. The method of claim 12, wherein the operational states of two of more of the software modules are configured to be controlled according to a same one of the commands.
